(19) United States
(12) Patent Application Publication
(10) Pub. No.: US 2021/0259301 A1
(43) Pub. Date: Aug. 26, 2021

(54) HEATED SEAM PUMP

(71) Applicant: SANTA FE NATURAL TOBACCO COMPANY, INC., Winston-Salem, NC (US)

(72) Inventor: Daniel S. KING, Winston-Salem, NC (US)

(21) Appl. No.: 16/797,965

(22) Filed: Feb. 21, 2020

(51) Int. Cl. A24C 1/34

(52) U.S. Cl. CPC A24C 1/34

(57) ABSTRACT

A system for applying adhesive to wrapping material for smoking articles includes a housing configured to receive the adhesive from an adhesive holding component. The housing comprises an adhesive conduit in fluid communication with the adhesive holding component, the adhesive conduit configured to receive the adhesive from the adhesive holding component. A heater aperture extends at least partially through the housing, the heater aperture positioned adjacent to the adhesive conduit. The system further includes a pump coupled to the housing, the pump in fluid communication with the adhesive conduit and configured to apply the adhesive to the wrapping material. A heater is sized and configured to fit within the heater aperture. The heater is configured to heat the adhesive in the adhesive conduit to a target adhesive temperature that is greater than a normal operating temperature of the pump.

### TECHNICAL FIELD

The present disclosure relates to systems and methods for manufacturing smoking articles such as cigarettes.

### BACKGROUND

Smoking articles (e.g., cigarettes, etc.) typically include a combustible material (e.g., tobacco, etc.) secured within a wrapping material (e.g., material, etc.). The combustible material is placed on the wrapping material, and the wrapping material is rolled around the combustible material into a substantially cylindrical shape to create a substantially cylindrical smoking article. To secure the smoking article in the substantially cylindrical shape, adhesive is applied to one side of the wrapping material, and the other side of the wrapping material is secured to the adhesive, thereby creating a seam. Descriptions of cigarettes and the various components thereof are set forth in, for example, Tobacco Production, Chemistry and Technology, Davis et al. (Eds.) (1999), U.S. Pat. No. 7,503,330 to Borschke et al., U.S. Pat. No. 5,360,023 to Blakley et al., U.S. Pat. No. 4,911,184 to Case et al., U.S. Pat. Pub. No. 2013/0167851 by Ademe et al., U.S. Pat. No. 9,247,770 to Barnes et al., and U.S. Pat. No. 8,574,141 to Barnes et al., all of which are incorporated herein by reference.

In an adhesive application process, it is important to apply the appropriate amount of adhesive to the seam. If not enough adhesive is applied, the seam may separate, causing a failure of the smoking article. Adhesive is typically applied at a specific rate by a pump based on the type of smoking article and the viscosity of the adhesive being used. However, the viscosity of the adhesive may change based on the temperature of the environment and the pump, thereby creating difficulty in accurately applying the desired amount of adhesive to the seam.

### SUMMARY

One embodiment relates to a system for applying adhesive to wrapping material for smoking articles. In this embodiment, a housing is configured to receive the adhesive from an adhesive holding component. According to this embodiment, the housing comprises an adhesive conduit in fluid communication with the adhesive holding component, the adhesive conduit configured to receive the adhesive from the adhesive holding component. In this embodiment, a heater aperture extends at least partially through the housing, the heater aperture positioned adjacent to the adhesive conduit. According to this embodiment, a pump is coupled to the housing, and the pump is in fluid communication with the adhesive conduit and configured to apply the adhesive to the wrapping material. In this embodiment, a heater is sized and configured to fit within the heater aperture. According to this embodiment, the heater is configured to heat the adhesive in the adhesive conduit to a target adhesive temperature that is greater than a normal operating temperature of the pump.

Another embodiment relates to a method for applying adhesive to wrapping material for smoking articles. In this embodiment, an adhesive application system is provided. The adhesive application system, in this embodiment, includes a housing configured to receive the adhesive from an adhesive holding component, the housing comprising an adhesive conduit in fluid communication with the adhesive holding component. In this embodiment, the adhesive conduit is configured to receive the adhesive from the adhesive holding component. According to this embodiment, a heater aperture extends at least partially through the housing, the heater aperture positioned adjacent to the adhesive conduit. A pump is coupled to the housing in this embodiment, and the pump is in fluid communication with the adhesive conduit and configured to apply the adhesive to the wrapping material. According to this embodiment, a heater is sized and configured to fit within the heater aperture. In this embodiment, the heater is configured to heat the adhesive in the adhesive conduit to a target adhesive temperature that is greater than a normal operating temperature of the pump. In this embodiment, determining determination is made as to whether a temperature of the heater is lower than the target adhesive temperature, and in response to determining the temperature of the heater is lower than the target adhesive temperature, the heater is directed to reach the target adhesive temperature.

Still another embodiment relates to an adhesive application system comprising a housing configured to receive an adhesive from an adhesive holding component. In this embodiment, the housing includes an adhesive conduit in fluid communication with the adhesive holding component, the adhesive conduit configured to receive the adhesive from the adhesive holding component. According to this embodiment, a pump is coupled to the housing, the pump in fluid communication with the adhesive conduit, the pump configured to apply the adhesive to a wrapping material for a smoking article. In this embodiment, a heater is operably coupled to the housing, the heater configured to heat the adhesive in the adhesive conduit to a target adhesive temperature. A controller is operably coupled to the heater. The controller, in this embodiment, is configured to determine whether a temperature of the heater is lower than the target adhesive temperature. In response to determining that the temperature of the heater is lower than the target adhesive temperature, in this embodiment, the controller directs the heater to reach the target adhesive temperature

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore not to be considered limiting of its scope, the disclosure will be described with additional specificity and detail through use of the accompanying drawings. Exemplary embodiments of the present application will now be described, by way of example only, with reference to the accompanying drawings, which are not necessarily drawn to scale, and wherein:

FIG. 1 is an illustration of an adhesive application system, according to a particular embodiment.

FIG. 2 is perspective view of a housing of the adhesive application system of FIG. 1.

FIG. 3 is a side view of the heater of the adhesive application system of FIG. 1.

FIG. 4 is a block diagram of the controller of the adhesive application system of FIG. 1.

FIG. 5 is an illustration of a method for heating and applying adhesive, according to a particular embodiment.

### DETAILED DESCRIPTION

Referring generally to the figures, a system and method for heating and dispensing an adhesive is shown. Smoking articles (e.g., cigarettes, etc.) may include a combustible material enclosed by a wrapping material, where the wrapping material is adhered to itself using adhesive, thereby creating a seam. In various embodiments, the wrapping material can include various papers, foils, laminates, etc. In some embodiments, the wrapping material includes tipping paper used for joining segments of a smoking article (e.g., as may be used to tip a filter segment to the tobacco rod of a cigarette). Applying the adhesive to the wrapping material is accomplished using a pump. Typically, the rate of adhesive application is set at the beginning of a manufacturing run, when the temperatures of the adhesive and the pump are relatively low (e.g., between approximately sixty degrees Fahrenheit and approximately seventy-five degrees Fahrenheit). As referred to herein, all temperatures are in Fahrenheit. The temperature of the adhesive can be relatively low at the beginning of a manufacturing run because the adhesive may be stored in a location different from that of the manufacturing location (e.g., a warehouse, etc.) and be transported to the manufacturing location just before the manufacturing run begins. The temperature of the pump can change during a manufacturing run as well. At the beginning of the manufacturing run, the temperature of pump may be substantially the same as that of the manufacturing environment (e.g., room temperature). As the pump runs during the manufacturing run, the temperature of the pump increases, which causes the temperature of the adhesive to increase as well.

As the temperature of the adhesive increases, the viscosity of the adhesive changes (e.g., the adhesive becomes more or less viscous). Because the viscosity of the adhesive at an increased temperature is different than the viscosity of the adhesive when the adhesive application rate is set, the pump can apply more or less adhesive than necessary to achieve the desired seam.

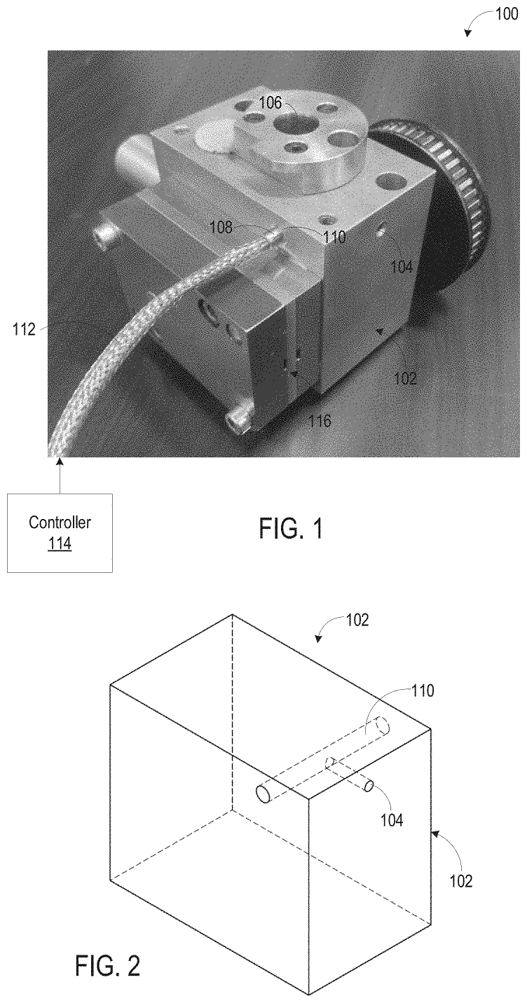

FIG. 1 is an illustration of an adhesive application system 100, according to a particular embodiment. FIG. 2 is perspective view of a housing 102 of FIG. 1. As shown in FIGS. 1-2, the adhesive application system 100 includes the housing 102, a heater 108, and a controller 114. The housing 102 further includes a set screw aperture 104, an adhesive channel 106, and a heater aperture 110. The heater 108 further includes a heater connector 112.

The housing 102 is operably coupled to an adhesive holding component (not shown) and to the pump 116. The housing 102 of the illustrated embodiment includes an adhesive conduit through which the adhesive flows from the adhesive holding component and the adhesive channel, and through the pump 116. The housing 102 of this embodiment can comprise any material suitable to withstand the temperatures of the adhesive and/or the heater 108 and/or the pump 116. For example, the housing 102 of this embodiment can comprise one or more metals (e.g., brass, stainless steel, aluminum, etc.), one or more plastics (e.g., Acrylonitrile Butadiene Styrene (ABS), polycarbonate, etc.), a combination thereof, or any other suitable materials.

As described herein, the adhesive used with the adhesive application system 100 of the illustrated embodiment can be any type of adhesive suitable for securing wrapping material in a smoking article. In some embodiments, the adhesive can be a starch-based adhesive. The adhesive can also be polyvinyl acetate (PVA) or any other type of adhesive that can secure wrapping material around a combustible material in a smoking article. The viscosity of the adhesive can be between 500 and 3800 centiPoise (cP), depending on the type of adhesive and the temperature of the adhesive.

The heater aperture 110 is an opening in the housing 102 and is sized and configured to receive the heater 108. In some embodiments, the heater aperture 110 can extend entirely through the housing 102. In some embodiments, the heater aperture 100 does not extend entirely through the housing 102. The heater aperture 110 of the illustrated embodiment can be any size and/or shape sufficient to allow the heater 108 to extend within the heater aperture. In some embodiments, the heater aperture 110 is substantially cylindrical in cross-section.

In some embodiments, the heater aperture 110 is positioned adjacent to (e.g., less than one half inch from) an adhesive conduit (not shown). The adhesive conduit is fluidly coupled to the adhesive channel 106, in some embodiments, and is configured to direct adhesive from the adhesive channel 106 into the housing 102, and to direct adhesive from the housing 102 into the pump 116. Heat provided by the heater 108 of the illustrated embodiment is conducted through the housing 102 to the adhesive conduit, where the adhesive flowing through the adhesive conduit is heated.

The set screw aperture 104 of this embodiment is an opening in the housing 102 oriented substantially perpendicularly (e.g., between eighty-five and ninety-five degrees) to the heater aperture 110 such that the set screw aperture 104 intersects the heater aperture 108. The set screw aperture 104 of this embodiment is sized and configured to receive a set screw (e.g., a screw with a blunt tip). In some embodiments, a diameter of the set screw aperture 104 is smaller than the diameter of the heater aperture 108.

In some embodiments, the pump 116 is operably coupled to the housing 102 and is configured to move the adhesive from the adhesive holding component, through the housing 102, through the pump 116, and through a dispenser (not shown) configured to apply the adhesive to the wrapping material. Examples of the pump 116 of the illustrated embodiment include, but are not limited to, a gear pump, a piston pump, a diaphragm pump, a screw pump, a vane pump, a peristaltic pump, etc. In some embodiments, the rate of adhesive applied by the pump 116 can be controlled by a controller (e.g., the controller 114) or by a user.

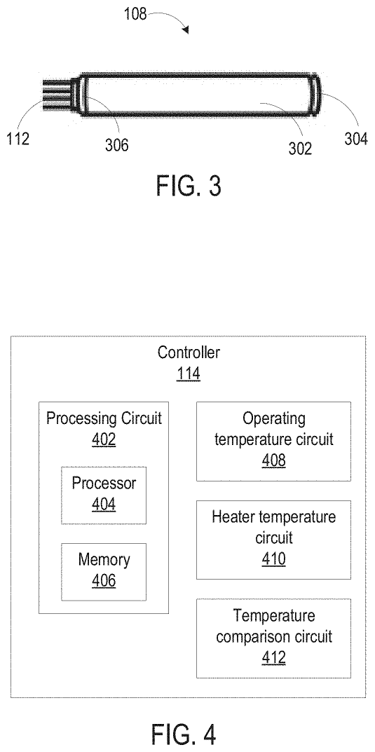

The heater 108 of the illustrated embodiment is sized and configured to fit within the heater aperture 110 and is operably coupled to the heater connector 112 and the controller 114. The heater 108 of this embodiment can be any type of heater that can be configured by a controller (e.g., the controller 114) to maintain a substantially constant temperature (e.g., plus or minus five degrees from a temperature set point). In some embodiments, the heater 108 includes, but is not limited to, a cartridge heater, an insertion heater, etc. The position of the heater 108 within the heater aperture 110 of the illustrated embodiment can be adjusted by securing the set screw in various locations along the heater 108. In some embodiments, to position the heater 108 such that approximately the entire length of the heater 108 is positioned within the heater aperture 110, the set screw can be secured to the heater 108 near the heater connector 112. The heater is further described with reference to FIG. 3.

In some embodiments, the heater 108 includes a temperature sensor (e.g., a thermocouple, etc.) that is in communication with the controller 114. The temperature sensor provides the controller 114 with data indicative of the temperature of the heater 108, and the controller 114 can modify temperature settings associated with the heater 108 based on the data received from the temperature sensor.

In some embodiments, the controller 114 is operably coupled to the heater 108 via the heater connector 112 and is configured to maintain a temperature of the heater 108 at a substantially constant value. In some embodiments, the value is provided by a user to the controller 114 via a user interface. The value is determined by the controller 114, in some embodiments, based on data received by the controller 114. In some embodiments, one or more sensors (not shown) may be coupled to the housing 112 and/or the gear pump 116 to determine a temperature of the housing 112 and/or the gear pump 116, and the controller 114 determines the temperature at which the heater 108 should be set based on the information received from the sensors. The controller 114 is further described with reference to FIG. 4.

As described, the adhesive application system 100 of the illustrated embodiment is configured to raise a temperature of the adhesive flowing through the adhesive conduit to a target adhesive temperature and maintain the adhesive at the target adhesive temperature during a manufacturing run. In some embodiments, the target adhesive temperature is approximately twenty to thirty degrees higher than a normal operating temperature of the adhesive dispensing system 100 (e.g., a normal operating temperature is the temperature of the adhesive dispensing system 100 during a manufacturing run when the heater 108 is not in use). When the adhesive is maintained at the target adhesive temperature, a viscosity of the adhesive is maintained at a substantially constant value. Accordingly, the adhesive application rate of the pump 116 of the illustrated embodiment can be set when the adhesive reaches the target adhesive temperature to ensure the viscosity of the adhesive will remain substantially the same during the manufacturing run. By ensuring the viscosity of the adhesive remains substantially the same during the manufacturing run, the amount of adhesive applied during the manufacturing run will remain substantially constant, thereby eliminating the problem of applying more or less adhesive than necessary to ensure an acceptable seam.

FIG. 3 is a side view of the heater 108 of FIG. 1. The heater 108 is shown to include a heating portion 302, a tip 304, and a base 306. The heating portion 302 of the illustrated embodiment is operably coupled to the controller 114 via the heater connector 112, and is configured to increase in temperature as directed by the controller 114. The tip 304 and the base 306 of this embodiment are not operably coupled to the controller 114; accordingly, in this embodiment the controller 114 does not direct the tip 304 and the base 306 to increase in temperature.

FIG. 4 illustrates a block diagram of the controller 114 of FIG. 1, in accordance with some embodiments. In this embodiment, the controller 114 is shown to include various circuits and logic for implementing the operations described herein. More particularly, the controller 114 of the illustrated embodiment includes one or more of a processing circuit 402, an operating temperature circuit 408, a heater temperature circuit 410, and a temperature comparison circuit 412. While various circuits, interfaces, and logic with particular functionality are shown, it should be understood that the controller 114 of the illustrated embodiment includes any number of circuits, interfaces, and logic for facilitating the operations described herein. In some embodiments, the activities of multiple circuits are combined as a single circuit and implemented on the same processing circuit (e.g., the processing circuit 402), as additional circuits with additional functionality are included.

In some embodiments, the processing circuit 402 includes a processor 404 and a memory 408. The processor 404 of the illustrated embodiment is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 408 of this embodiment (e.g., Random Access Memory (RAM), Read-Only Memory (ROM), Non-volatile RAM (NVRAM), Flash Memory, hard disk storage, etc.) stores data and/or computer code for facilitating the various processes described herein. Moreover, the memory 408 of this embodiment is or includes tangible, non-transient volatile memory or non-volatile memory. Accordingly, in some embodiments the memory 408 includes database components, object code components, script components, and/or any other type of information structure for supporting the various activities and information structures described herein.

The operating temperature circuit 408 of the illustrated embodiment is configured to provide information regarding the operating temperature of the adhesive application system 100. In this regard, the operating temperature circuit 408 is structured, in some embodiments, to exchange data, communications, instructions, etc., with an input/output component operably coupled to the operating temperature circuit 408. Accordingly, in some embodiments, the input/output component can include one or more sensors configured to determine an operating temperature of the adhesive application system 100 (e.g., the temperature of the adhesive application system 100). The operating temperature circuit 408 of the illustrated embodiment is operatively coupled to one or more components of the controller 114. In some embodiments, the operating temperature circuit is operatively coupled to the temperature comparison circuit 412 to provide the temperature comparison circuit 412 with operating temperature information.

The heater temperature circuit 410 of this embodiment is configured to provide information regarding the temperature of the heater 108. In some embodiments, the heater temperature circuit 410 is structured to exchange data, communications, instructions, etc., with an input/output component operably coupled to the heater temperature circuit 410. Accordingly, in some embodiments, the input/output component can include one or more sensors configured to determine a temperature of the heater 108. The heater temperature circuit 410 of this embodiment is operatively coupled to one or more components of the controller 114. In some embodiments, the heater temperature circuit 410 is operatively coupled to the temperature comparison circuit 412 to provide the temperature comparison circuit 412 with information regarding the temperature of the heater 108.

The temperature comparison circuit 412 of this embodiment is configured to compare an operating temperature of the adhesive application system 100 and a temperature of the heater 108 and determine whether the temperature of the heater 108 should be changed. In some embodiments, the temperature comparison circuit 412 is structured to exchange data, instructions, etc., with the operating temperature circuit 408 and the heater temperature circuit 410. The temperature comparison circuit 412 of this embodiment is operatively coupled to one or more components of the controller 114. In some embodiments, the temperature comparison circuit is operatively coupled to the processing circuit 402 to provide the processing circuit with information with information regarding the temperatures of the heater 108 and the pump 116.

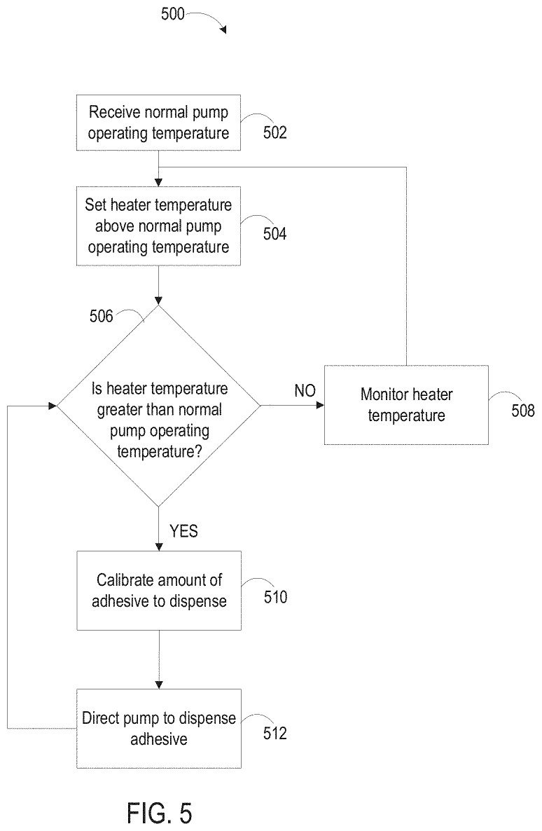

FIG. 5 is an illustration of a method 500 for heating and applying adhesive, according to a particular embodiment. In some embodiments, the method 500 is implemented by the adhesive application system 100.

At 502 of the illustrated embodiment, an indication of the normal operating temperature of the pump 116 is received. As used herein, the “normal operating temperature” refers to the temperature of the pump 116 during operation without additional heat provided by the heater 108. In some embodiments, the normal operating temperature of the pump 116 can be sensed by one or more temperature sensors (e.g., thermocouples, etc.) coupled to the pump 116 and the controller 114. The indication of the normal operating temperature of the pump 116 of the illustrated embodiment is then received by the operating temperature circuit 408 of the controller 114, and the normal operating temperature is stored in the memory 406. In some embodiments, the normal operating temperature of the pump 116 may be determined during previous manufacturing runs and stored in the memory 406.

At 504 of this embodiment, a temperature of the heater 108 is set higher than the normal operating temperature of the pump 116. In some embodiments, the processor 404 may direct the heater temperature circuit 410 to set a temperature of the heater 108 to approximately twenty to thirty degrees higher than the normal operating temperature of the pump 116. In some embodiments, the processor 404 may direct the heater temperature circuit 410 to set a temperature of the heater 108 to exceed a normal operating temperature of the pump 116 by a threshold amount. The threshold amount may, in some embodiments, be ten percent, fifteen percent, etc., greater than the normal operating temperature of the pump 116. In some embodiments, the threshold amount may also be based on a temperature value instead of a percentage (e.g., two degrees greater, ten degrees greater, thirty degrees greater, etc.). Setting the temperature of the heater 108 of the illustrated embodiment above the normal operating temperature of the pump 116 ensures the viscosity of the adhesive remains substantially constant throughout the manufacturing run.

At 506 of the illustrated embodiment, a determination is made as to whether the temperature of the heater 108 is greater than the normal operating temperature of the pump 116. In some embodiments, the temperature comparison circuit 412 receives data indicative of the normal operating temperature of the pump 116 via the operating temperature circuit 408 (or via the memory 406) and the temperature of the heater 108 via the heater temperature circuit 410. The temperature comparison circuit 412 of the illustrated embodiment compares the temperatures to determine if the temperature of the heater 108 is greater than the normal operating temperature of the pump 116. In some embodiments, the temperature comparison circuit 412 determines if the temperature of the heater 108 has reached a target adhesive temperature, where the target adhesive temperature is a temperature greater than the normal operating temperature of the pump 116 by the threshold amount. As used herein, “target adhesive temperature” is also intended to encompass a specific temperature value and a designated tolerance value therearound (e.g., the specific temperature plus a designated temperature range or percentage thereabove).

In various embodiments, if the temperature comparison circuit 412 determines that the temperature of the heater 108 is not greater than the normal operating temperature of the pump 116, at 508 the temperature comparison circuit 412 continues to monitor the temperature of the heater 108, and the heater temperature circuit ensures that the heater temperature is set to a temperature above the normal pump operating temperature at 504. In some embodiments, the temperature comparison circuit 412 directs the heater 108 to reach the target adhesive temperature. In some embodiments, the temperature of the heater 108 may be properly set, however the temperature of the heater 108 has not yet reached the target adhesive temperature. In such embodiments, at 508 the temperature comparison circuit continues to monitor the temperature of the heater 108 until the temperature of the heater 108 reaches the target adhesive temperature.

If the temperature comparison circuit 412 of the illustrated embodiment determines that the temperature of the heater 108 is greater than the normal operating temperature of the pump 116 by more than the threshold amount, the controller 114 directs the heater 108 to stop heating until the heater 108 cools down to the target adhesive temperature.

If the temperature comparison circuit 412 of this embodiment determines that the temperature of the heater 108 is greater than the normal operating temperature of the pump 116 (e.g., the temperature of the heater 108 has reached the target adhesive temperature), at 510 the amount of adhesive to dispense is calibrated. In some embodiments, the controller 114 may direct the pump 116 to dispense the adhesive at a baseline flowrate (e.g., 1 milliliter per second) for a specified period (e.g., 0.2 seconds, 0.5 seconds, etc.). In some embodiments, the baseline flowrate may be based on the target adhesive temperature, where the target adhesive temperature corresponds to a viscosity of the adhesive. After dispensing the adhesive at the baseline flowrate, in some embodiments the controller 114 determines whether the appropriate amount adhesive has been dispensed to secure the wrapping material. The appropriate amount of adhesive can be determined, in some embodiments, by a volume of adhesive dispensed, a weight of adhesive dispensed, or any other value that may indicate the amount of adhesive dispensed.

If the controller 114 of this embodiment determines that the appropriate amount of adhesive has been dispensed, at 512 the pump 116 is directed to apply adhesive to wrapping material. In some embodiments, the controller 114 is operably coupled to the pump 116, and can direct the operation of the pump 116. The controller 114 of this embodiment may also be operably coupled to a pump controller (not shown) that controls operation of the pump 116.

If the controller 114 of the illustrated embodiment determines that more or less adhesive must be dispensed to secure the wrapping material (e.g., the appropriate amount of adhesive was not dispensed at the baseline flowrate), the controller 114 modifies the flowrate at which the adhesive is dispensed until the appropriate amount of adhesive is dispensed. In some embodiments, the flowrate can be adjusted by a user instead of the controller 114.

As described, because the heater 108 of the illustrated embodiment raises the temperature of the adhesive such that the temperature of the adhesive is greater than the normal operating temperature of the pump 116, the viscosity of the adhesive is substantially constant when the adhesive is applied by the adhesive application system 100. Accordingly, in some embodiments the appropriate amount of adhesive is applied to the wrapping material for a smoking article, and the issue of an inadequate seam is avoided.

As utilized herein, the term “substantially,” “approximately,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative embodiments. Other substitutions, modifications, changes, and omissions may also be made in the design, operating conditions and arrangement of the various exemplary embodiments without departing from the scope of the present invention.

What is claimed is:

1. A system for applying adhesive to wrapping material for smoking articles, comprising:
a housing configured to receive the adhesive from an adhesive holding component, the housing comprising:
an adhesive conduit in fluid communication with the adhesive holding component, the adhesive conduit configured to receive the adhesive from the adhesive holding component; and
a heater aperture extending at least partially through the housing, the heater aperture positioned adjacent to the adhesive conduit;
a pump coupled to the housing, the pump in fluid communication with the adhesive conduit, the pump configured to apply the adhesive to the wrapping material; and
a heater sized and configured to fit within the heater aperture, the heater configured to heat the adhesive in the adhesive conduit to a target adhesive temperature that is greater than a normal operating temperature of the pump.

2. The system of claim 1, further comprising a controller operably coupled to the heater, the controller configured to direct the heater to reach the target adhesive temperature.

3. The system of claim 1, further comprising a controller operably coupled to the heater, the controller configured to determine the target adhesive temperature and, in response to a determination that a temperature of the heater is below the target adhesive temperature, direct the heater to reach the target adhesive temperature.

4. The system of claim 3, wherein the controller comprises a temperature comparison circuit configured to determine the target adhesive temperature based on the normal operating temperature and a threshold amount.

5. The system of claim 1, further comprising:
a set screw aperture operably coupled to the heater aperture;
a set screw sized to fit within the set screw aperture; and
a heater sized to fit within the heater aperture, the heater secured within the heater aperture by the set screw.

6. The system of claim 5, wherein a position of the heater within the heater aperture is adjustable.

7. A method for applying adhesive to wrapping material for smoking articles, comprising:
providing an adhesive application system, the adhesive application system comprising:
a housing configured to receive the adhesive from an adhesive holding component, the housing comprising:
an adhesive conduit in fluid communication with the adhesive holding component, the adhesive conduit configured to receive the adhesive from the adhesive holding component; and
a heater aperture extending at least partially through the housing, the heater aperture positioned adjacent to the adhesive conduit;
a pump coupled to the housing, the pump in fluid communication with the adhesive conduit, the pump configured to apply the adhesive to the wrapping material; and
a heater sized and configured to fit within the heater aperture, the heater configured to heat the adhesive in the adhesive conduit to a target adhesive temperature that is greater than a normal operating temperature of the pump;
determining whether a temperature of the heater is lower than the target adhesive temperature; and
in response to determining that the temperature of the heater is lower than the target adhesive temperature, directing the heater to reach the target adhesive temperature.

8. The method of claim 7, further comprising:
determining whether a temperature of the heater is at the target adhesive temperature; and
in response to determining that the temperature of the heater is at the target adhesive temperature, applying the adhesive to the wrapping material.

9. The method of claim 8, further comprising:
receiving, by a controller operably coupled to the adhesive application system, the normal operating temperature for the pump; and
determining, by the controller, the target adhesive temperature based on the normal operating temperature and a threshold amount.

10. The method of claim 9, further comprising:
calibrating, by the controller, a calibrated amount of the adhesive to apply to the wrapping material, wherein the calibrated amount of the adhesive to apply is determined based on the target adhesive temperature.

11. The method of claim 10, further comprising:
in response to determining that the heater has reached the target adhesive temperature, directing, by the controller, the pump to apply the calibrated amount adhesive to the wrapping material.

12. The method of claim 11, further comprising:
in response to determining that the temperature of the heater is greater than the target adhesive temperature, directing, by the controller, the heater to reduce temperature until the heater reaches the target adhesive temperature.

13. An adhesive application system, comprising:
a housing configured to receive an adhesive from an adhesive holding component, the housing comprising an adhesive conduit in fluid communication with the adhesive holding component, the adhesive conduit configured to receive the adhesive from the adhesive holding component;
a pump coupled to the housing, the pump in fluid communication with the adhesive conduit, the pump configured to apply the adhesive to a wrapping material for a smoking article;
a heater operably coupled to the housing, the heater configured to heat the adhesive in the adhesive conduit to a target adhesive temperature; and
a controller operably coupled to the heater, the controller configured to determine whether a temperature of the heater is lower than the target adhesive temperature and, in response to determining that the temperature of the heater is lower than the target adhesive temperature, directing the heater to reach the target adhesive temperature.

14. The system of claim 13, further comprising a heater aperture extending at least partially through the housing, the heater aperture positioned adjacent to the adhesive conduit, the heater aperture configured to receive the heater.

15. The system of claim 14, wherein the target adhesive temperature is greater than a normal operating temperature of the pump.

16. The system of claim 13, wherein the controller is configured to determine whether a temperature of the heater is at the target adhesive temperature and, in response to determining that the temperature of the heater is at the target adhesive temperature, direct the pump to apply the adhesive to the wrapping material.

17. The system of claim 13, wherein the controller is configured to determine the target adhesive temperature and direct the heater to reach the target adhesive temperature.

18. The system of claim 17, wherein the controller comprises a temperature comparison circuit configured to determine the target adhesive temperature based on a normal operating temperature of the pump and a threshold amount.

19. The system of claim 14, further comprising:
a set screw aperture operably coupled to the heater aperture;
a set screw sized to fit within the set screw aperture; and
a heater sized to fit within the heater aperture, the heater secured within the heater aperture by the set screw.

20. The system of claim 19, wherein a position of the heater within the heater aperture is adjustable.
